(19) United States
(12) Patent Application Publication
(10) Pub. No.: US 2008/0289324 A1
(43) Pub. Date: Nov. 27, 2008

(54) Clean energy generator

(76) Inventors: Robert Marion, Garson (CA); Richard Woloshyn, Sudbury (CA)

Correspondence Address: DEVIAT-MIKE GAUTHIER, 355 GOODWILL DRIVE, BOX 400, GARSON, ON, P3L 1S7, CA

(21) Appl. No.: 11/802,602

(22) Filed: May 24, 2007

(51) Int. Cl. F03C 1/02

(52) U.S. Cl. 60/407

(57) ABSTRACT

An affordable system for the production of clean energy comprises a plurality of tubular columns, each sealed at the bottom, to contain water in most of its inner volume. A buoy having an opening at the very bottom and a mechanical valve at its top thereby becomes inflatable and deflatable at preset times in a cycle. Once made buoyant by letting air in the bottom opening—forcing most of the water out of the buoy—it thereby elevates to the very top of the column until it reached the top of the column where the column lid depresses the valve stem deflating the buoy thus lowering the buoy to the bottom to begin the cycle again. A chain and gears engage with a rotary alternator for the generation of electricity.

### FIELD OF THE INVENTION

The present invention relates to an affordable system for the production of clean energy. The system of the present invention comprises a plurality of tubular columns, each sealed at the bottom, to contain water in most of their inner volume. A buoy having a substantial opening at the very bottom and a mechanical valve at its top thereby becomes inflatable and deflatable at preset times in a cycle. Once made buoyant—by letting air in the bottom opening forcing most of the water out of the buoy—it thereby elevates to the very top of the column until it reached the top of the column where the column lid depresses the valve stem deflating the buoy thus lowering the buoy to the bottom to begin the cycle again. A chain and gears engage with a rotary alternator for the generation of electricity.

### BACKGROUND OF THE INVENTION

Power generation is a vital subject in meeting today's ever-increasing energy consumption needs, and along with many other methods, active buoyancy has also been implemented for the generation of electrical power. For the most part, these systems have been very costly to implement, very large thus altering or defacing the natural landscape, and require a higher level of maintenance to function properly. Additionally, the ecosystem is greatly affected by many of these installations. Furthermore, most prior art systems are not suitable for personal residential installation.

The inventor sought to provide homeowners with a small home-energy generator that is affordable, non-obtrusive and effective.

The applicant has retrieved several attempts in prior art that provide means of generating electrical energy using water as a source of renewable mechanical energy. Examples of prior art may be had by referencing U.S. Pat. Nos. 3,668,412 of Vrana, 4,001,596 of Kurtzbein, 4,326,840 of Hicks, 5,872,406 of Ullman, 6,803,670 of Peloquin, US Appl. No. 2005/0023836 of Abdalla, and JP absract 2004270674 of Toshimitsu.

Through the development of the generator of the present invention, the inventor was indeed able to overcome all of the above defects in prior art systems.

### SUMMARY OF THE INVENTION

It is thus the object of the present invention to provide homeowners with a small home-energy generator that is affordable, non-obtrusive and effective.

In one aspect of the invention, the resulting mechanical energy created by the present system may be utilized as either a mechanical source of energy or to drive alternators thus creating electrical energy for either storage or immediate use.

Accordingly, the device of the present invention therefore provides homeowners with an electrical power generator that is affordable, non-obtrusive and effective.

The utility of the present invention includes but is not limited to electrical power generation.

### BRIEF DESCRIPTION OF THE DRAWINGS

These and other advantages of the invention will become apparent upon reading the following brief description and upon referring to the drawings in which:

FIG. 1 is a right side elevation view of one of the columns of the clean energy generator of the present invention.

FIG. 2 is a cross-sectional view taken along lines 2-2 of FIG. 1 of the generator of the present invention.

FIG. 3 is a cross-sectional view taken along lines 3-3 of FIG. 1 of the generator of the present invention.

FIG. 4 is a semi-transparent right side elevation view of one of the columns of the clean energy generator of the present invention shown at stage 1.

FIG. 5 is a semi-transparent right side elevation view of one of the columns of the clean energy generator of the present invention shown at stage 2.

FIG. 6 is a semi-transparent right side elevation view of one of the columns of the clean energy generator of the present invention shown at stage 3.

FIG. 7 is a semi-transparent right side elevation view of one of the columns of the clean energy generator of the present invention shown at stage 4.

FIG. 8 is a semi-transparent right side elevation view of one of the columns of the dean energy generator of the present invention shown at stage 5.

FIG. 9 is a semitransparent right side elevation view of one of the columns of the clean energy generator of the present invention shown at stage 6.

FIG. 10 is a semitransparent right side elevation view of one of the columns of the clean energy generator of the present invention shown at stage 7.

FIG. 11 is a semi-transparent right side elevation view of one of the columns of the clean energy generator of the present invention shown at stage 8.

FIG. 12 is a semi-transparent right side elevation view of one of the columns of the clean energy generator of the present invention shown at stage 9.

FIG. 13 is a semitransparent right side elevation view of one of the columns of the clean energy generator of the present invention shown at stage 10.

While the invention is described in conjunction with preferred illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENT

In the following description, similar features in the drawings have been given similar reference numerals.

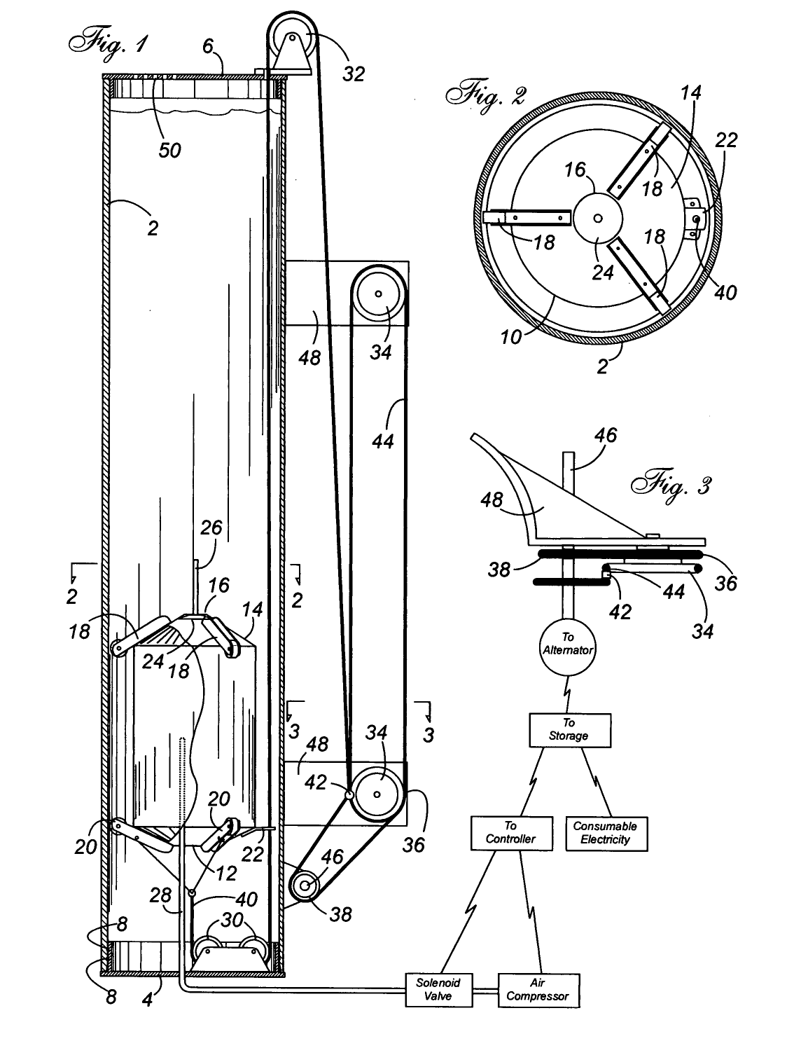

Turning to FIG. 1 a right side elevation view of one of the columns of the clean energy generator of the present invention wherein each column 2 assembly comprises: a water-filled vertical column 2 further comprising: a vertically tubular pipe adapted with a watertight end cap 4 at its bottom and a ventilated lid 6 at the top of said column 2 wherein the bottom end cap 4 further comprises: a planar circular disc extending slightly beyond the column's 2 diameter and an inwardly raised edge adapted with rubber seals 8 at its outer diameter so as to frictionally and sealably engage with the inner wall surface of the column 2 thus forming a water-tight seal, a buoyancy-adjustable buoy 10 comprising: a cylindrical body having an opening 12 at the bottom, an upwardly conical top 14 having an outlet 16 through its center, top guidance rollers 18 arrayed in such a manner as to form an outer diameter slightly lesser than that of the inner diameter of the column's 2 inner wall surface, bottom guidance rollers 20 arrayed in such a manner as to form an outer diameter slightly lesser than that of the inner diameter of the column's 2 inner wall surface so as to prevent undue friction between the buoy 10 and the inner surface of the column 2, a chain and gear drive system for motion transmission, a chain guide 22 to prevent rotational motion of the buoy 10, a buoy valve 24 having an upward stem 26 protruding the buoy's center top outlet 16, and a semi-resilient rubber disk under the outlet 16 having an outer diameter greater than the outlet 16 diameter, and a stem guide atop the outlet 16 so as to maintain a vertical attitude of the stem 26 when stem 26 is displaced upwardly or downwardly, an air supply tube 28 further comprising a vertically disposed tube 28 positioned slightly off center in the column 2, and protruding substantially upwardly within the lower opening 12 of the buoy 10 and extending the greater height of the buoy 10 when the buoy 10 is at its lowest disposition within the column 2.

The drive system comprises: two lower column sprockets 30, one upper column sprocket 32, a buoy chain guide 22, and a transfer chain 40 attached to collector lines below the buoy 10, then engaged below the two lower column sprockets 30, through the buoy chain guide 22, through the column lid 6, over the upper column sprocket 32, terminating at a tie point 42 on the loop chain 44 engaged onto the two loop sprockets 34, a low-speed drive sprocket 36 fixedly engaged with the lower loop sprocket 34 and sharing a common axis, and a high-speed drive sprocket 38 engaged with a community drive rod 46.

The water level in the column 2 is at its highest when the buoy 10 is inflated and buoyant and the water in the column 2 is continually reused while a water source automatically refills the column 2 when water levels descend due to evaporation.

Two or more column assemblies are arrayed to provide constant rotational force to the drive rod 46 via the drive system.

The drive rod 46 is a single rod shared by all drive sprockets 38 from any number of column assemblies and transfers the combined rotational force from all drive sprockets 38 to a single alternator.

Turning to FIG. 2, a cross-sectional view taken along lines 2-2 of FIG. 1 of the generator of the present invention wherein the guide rollers 18 and 20 can be better appreciated forming a tri-point within the column 2 thus preventing swaying of the buoy 10 during its ascending and descending motions. The chain guide 22 is also well depicted wherein the transmission chain 40 traverses an opening through said guide 22 thereby maintaining anti-rotational alignment of the buoy 10 with respect to the chain 40.

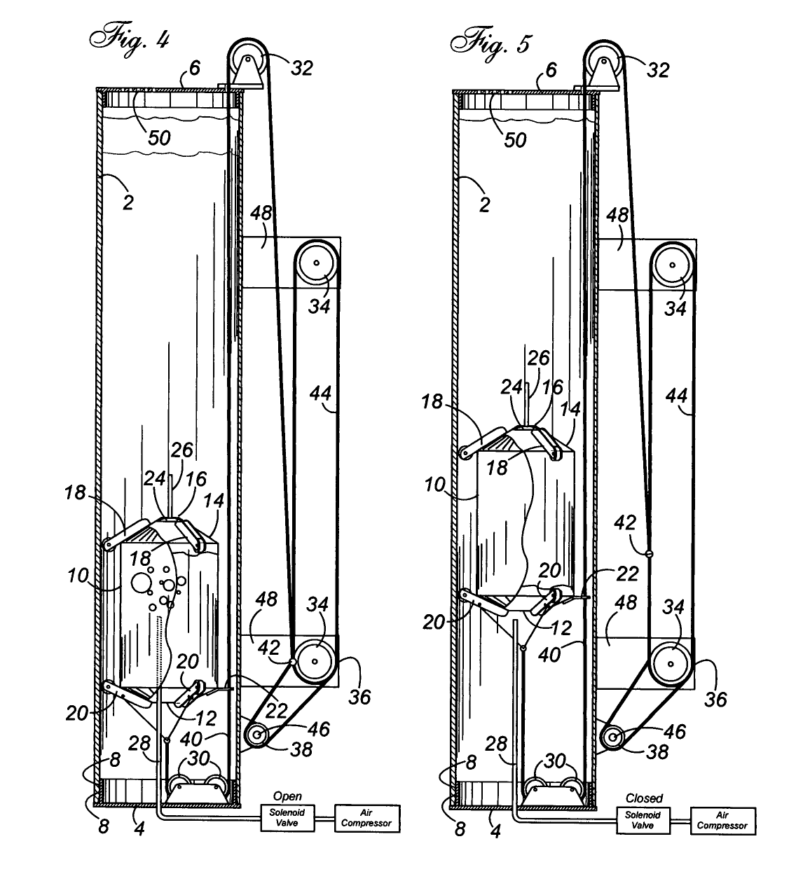

Turning to FIG. 3, also a cross-sectional view, taken along lines 3-3 of FIG. 1 of the generator of the present invention wherein a sprocket bracket 48 having a mating column-contacting portion for fastening thereto, and a combination of sprockets for the conversion of linear motion into rotational motion.

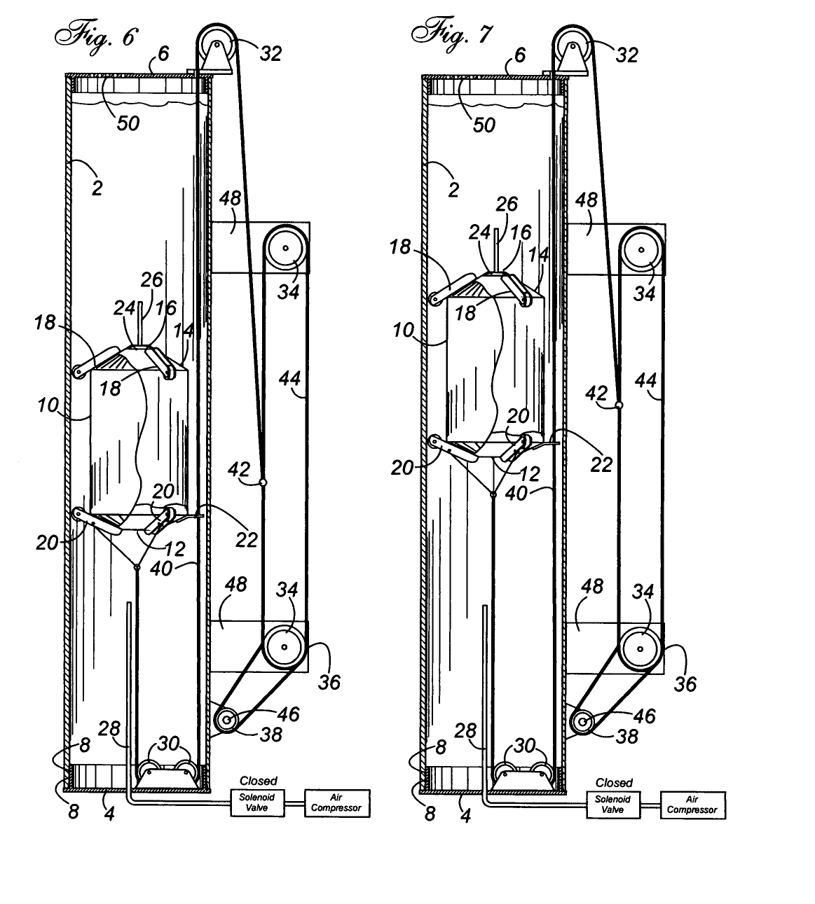

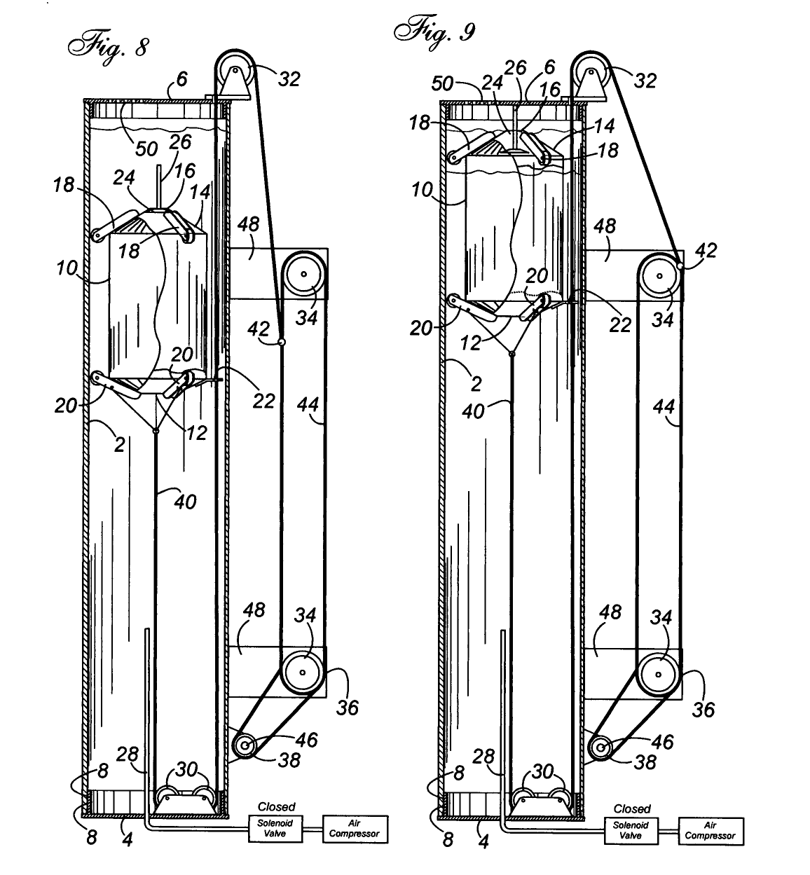

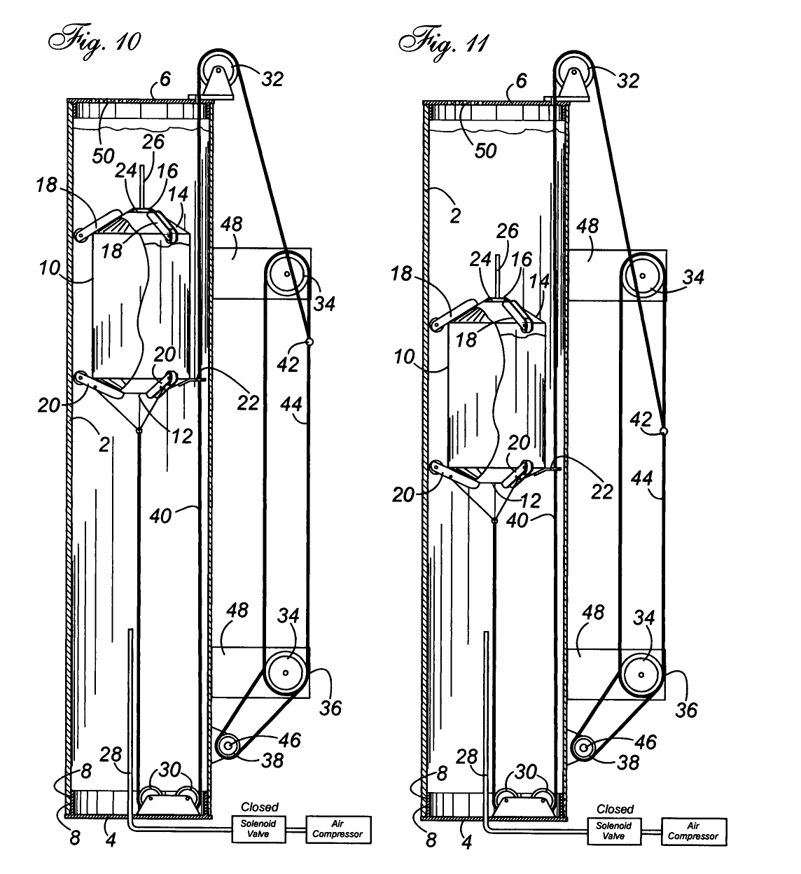

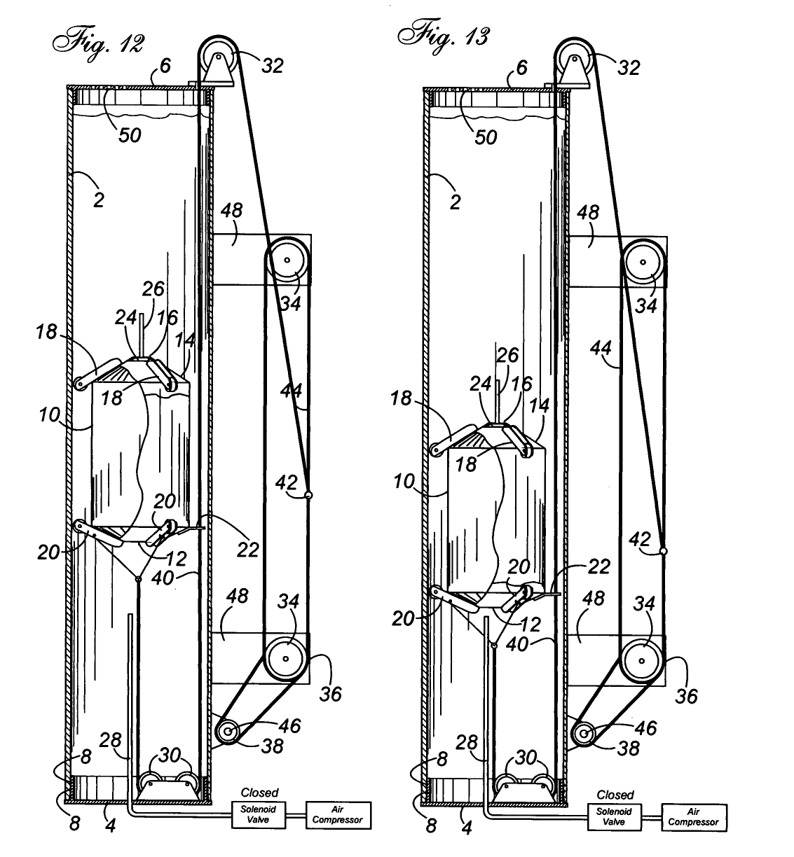

Turning now to FIGS. 4 through 13, all right side elevation views of one the column assemblies of the clean energy generator of the present invention wherein one can visualize the various incremental stages each cylinder 2 goes to in order to generate the linear motion of the loop chain 44. In particular, FIG. 9 depicts that the valve stem 26 gets depressed by contacting the underside of the column lid 6, thus breaking the seal previously formed by said valve 24. This now allows all the air within the buoy 10 to escape to the upper portion of the column 2, then through the vent 50 in the column lid 6 to the ambient air. The buoy 10 has now lost its buoyancy and begins to descend gravitationally to the very bottom of the column 2. At the same time, the loop chain carries this column's transmission chain 40 end to the descending side of the loop chain 44. The synchronization of the plurality of column assemblies thus calibrated so as to be cohesive in this continual motion thereby ensures proper directional attitudes of all column assemblies' drive system.

It can be understood that only a small amount of air pressure is required to fill the buoy 10 with air and make it buoyant, thus the energy requirement to operate a small energy-efficient air compressor is minimal in comparison to the system's power output. Therefore, an excess of power will be generated and stored for immediate or future consumption.

1. A clean energy generator comprising:
a) an array of column assemblies each comprising:
i. a water-filled vertical column,
ii. a buoyancy-adjustable buoy,
iii. a chain and gear drive system for motion transmission, and
iv. an air tube for inflating the buoy,
b) an alternator, and
c) an air compressor.

2. The clean energy generator of claim 1 wherein each vertical column further comprises a tubular pipe adapted with a watertight end cap at the bottom and ventilated lid at the top of the column.

3. The clean energy generator of claim 2 wherein the end cap further comprises a planar circular disc extending slightly beyond the column's diameter and an inwardly raised edge adapted with rubber seals at its outer diameter so as to frictionally and sealably engage with the inner wall surface of the column.

4. The clean energy generator of claim 1 wherein the buoy further comprises:
a. a cylindrical body having an opening at the bottom, a conical top having an outlet therethrough its center,
b. top guidance rollers arrayed in such a manner as to form a diameter slightly lesser than the inner diameter of the column,
c. bottom guidance rollers arrayed in such a manner as to form a diameter slightly lesser than the inner diameter of the column,
d. a chain guide to prevent rotational motion of the buoy,
e. a valve having an upward stem protruding the center top outlet, and a semi-resilient rubber disk under the outlet having an outer diameter greater than the outlet diameter, and
f. a stem guide atop the outlet so as to maintain a vertical attitude of the stem when stem is displaced upwardly or downwardly.

5. The clean energy generator of claim 1 wherein the air tubes further comprise a vertically disposed tube positioned slightly off center in the column, and protruding upwardly within the lower opening of the buoy.

6. The clean energy generator of claim 5 wherein the air tube extends the greater height of the buoy when the buoy is at its lowest disposition within the column.

7. The clean energy generator of claim 1 wherein the water level in the column is at its highest when the buoy is inflated and buoyant.

8. The clean energy generator of claim 1 wherein the water in the column is continually reused.

9. The clean energy generator of claim 1 wherein a water source automatically refills the column when water levels descend due to evaporation.

10. The clean energy generator of claim 1 wherein the drive system comprises: two lower column sprockets, one upper column sprocket, a buoy chain guide, and a transfer chain attached to collector lines below the buoy, then engaged below the two lower column sprockets, through the buoy chain guide, through the column lid, over the upper column sprocket, terminating at a tie point on the loop chain engaged onto the two loop sprockets, two loop sprockets, a low-speed drive sprocket fixedly engaged with the lower loop sprocket and sharing a common axis, and a high-speed drive sprocket engaged with a community drive rod.

11. The clean energy generator of claim 1 wherein two or more column assemblies are arrayed to provide constant rotational force to the system.

12. The clean energy generator of claim 1 wherein the drive rod is a single rod shared by all drive sprockets of any number of column assemblies.

13. The clean energy generator of claim 12 wherein the drive rod transfers the combined rotational force of all drive sprockets to a single alternator.
